(19) United States
(12) Patent Application Publication
(10) Pub. No.: US 2004/0089115 A1
(43) Pub. Date: May 13, 2004

(54) Handle assembly for hand tools

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/289,321

(22) Filed: Nov. 7, 2002

(51) Int. Cl. B25B 23/16

(52) U.S. Cl. 81/177.1

(57) ABSTRACT

A handle assembly for hand tools includes a handle body having a plurality of recesses defined in two opposite sides thereof and two grip parts each have a plurality of insertions which are securely inserted into the recesses of the handle body. The grip parts are connected to the handle body without any machine needed.

### FIELD OF THE INVENTION

The present invention relates to a handle assembly for a hand tool and particularly, to a snap-on type grip which is easily connected to the handle without requiring any expensive machines.

### BACKGROUND OF THE INVENTION

A conventional hand tool such as a wrench or screw driver generally includes a shank with a handle on a first end and a function end such as an open end wrench on a second end of the shank. A grip is connected to the handle so that the user may hold the handle without slippery. The handle includes two opposite wide sides and two opposite narrow sides, and the force to rotate the shank should be applied perpendicularly to the narrow sides.

A first type of grip is composed of two parts which are respectively connected to the two opposite wide sides of the handle. Therefore, when using the tool, the hand of the user contacts the narrow sides of the handle where no grip part is located.

Another type of grip is wrapped around the handle and generally made of plastic or rubber which is injected onto the handle by a plastic injection machine. Although this type of grip improves the shortcoming of the first type of the conventional grip, it requires costly machine to connect the grip on the handle.

The present invention intends to provide a handle of a hand tool wherein the grip is snapped onto the handle conveniently without any machine assistance.

### SUMMARY OF THE INVENTION

In accordance with one aspect of the present invention, there is provided a handle assembly for hand tools and the handle assembly comprises a handle body having a plurality of recesses in two opposite sides thereof and two grip parts each have a plurality of insertions extending from a side thereof. The insertions are securely inserted into the recesses of the handle body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the handle assembly of the present invention;

FIG. 2 is a cross sectional view to show the handle body and the two grip parts of the present invention;

FIG. 3 is a perspective view to show the hand tool with the two grip parts;

FIG. 4 is a cross sectional view to show the two grip parts are connected to the handle body;

FIG. 5 shows a connection member is connected between the two grip parts;

FIG. 6 is an exploded view to show another embodiment of the handle assembly of the present invention, and

FIG. 7 shows the two grip parts as shown in FIG. 6 is connected to the handle body of the hand tool.

### DETAILED DESCRIPTION OF THE PREFERRED EMBODIMENT

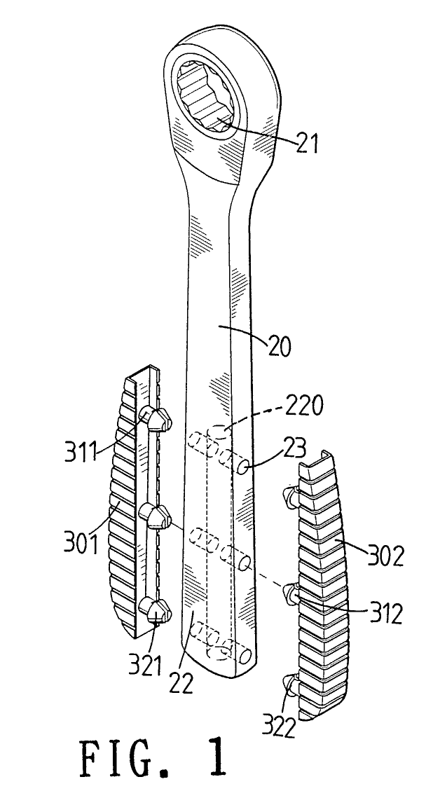

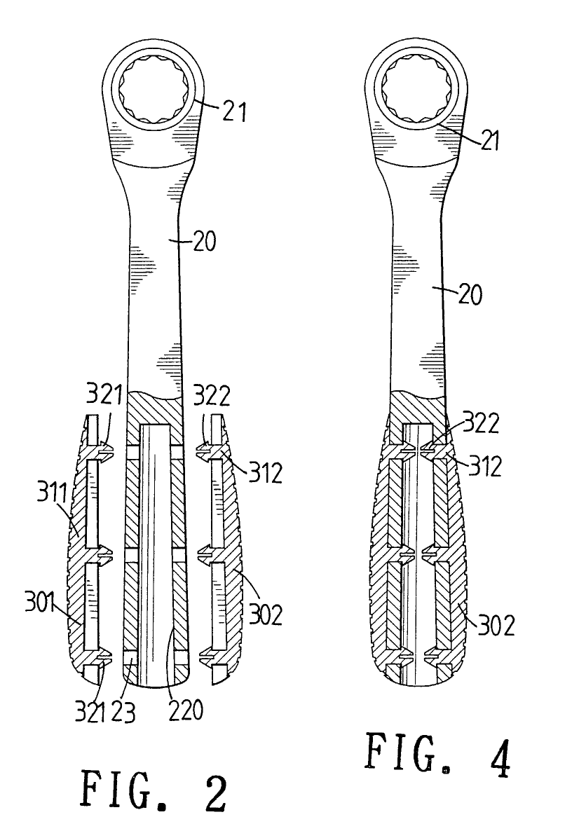

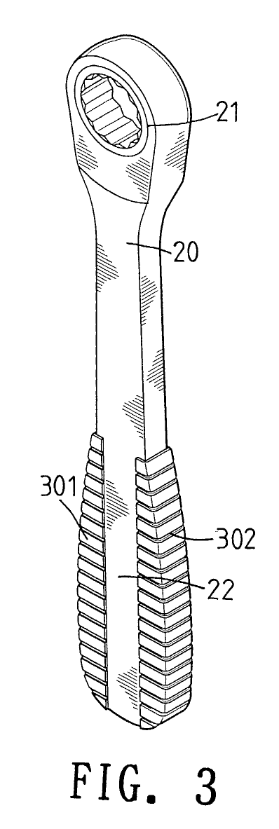

Referring to FIGS. 1 to 4, a hand tool includes a shank 20 with a ratchet close-ended box at a first end of the shank 20 and a handle body 22 at a second end of the shank 20. The handle assembly for the hand tool of the present invention comprises a plurality of recesses 23 defined in two opposite sides of the handle body 22 and a passage 220 is defined in a distal end of the handle body 22 and communicates with the recesses 23.

Two grip parts 301, 302 each have a plurality of insertions 311/312 extending from a side thereof. The insertions 311, 312 are securely inserted into the recesses 23 of the handle body 22. Each of the insertions 311, 312 has an enlarged head 321/322 which includes a slit so that each enlarged head 321/322 is composed of two halves separated by the slit. The two halves are narrowed when passing through the recesses 23 and then bounce back to their original size and received in the passage 220. By this way, the two grip parts 301, 302 are conveniently connected to the handle body 22 without any machine needed.

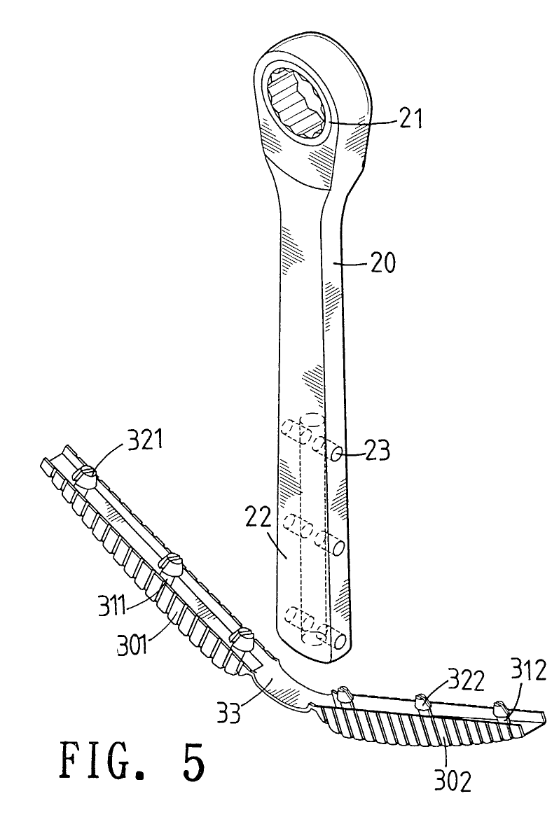

FIG. 5 shows that a connection piece 33 is connected between the two grip parts 301, 302 so that the two grip parts 301, 302 are easily stored and transported before they are connected to the handle body 22.

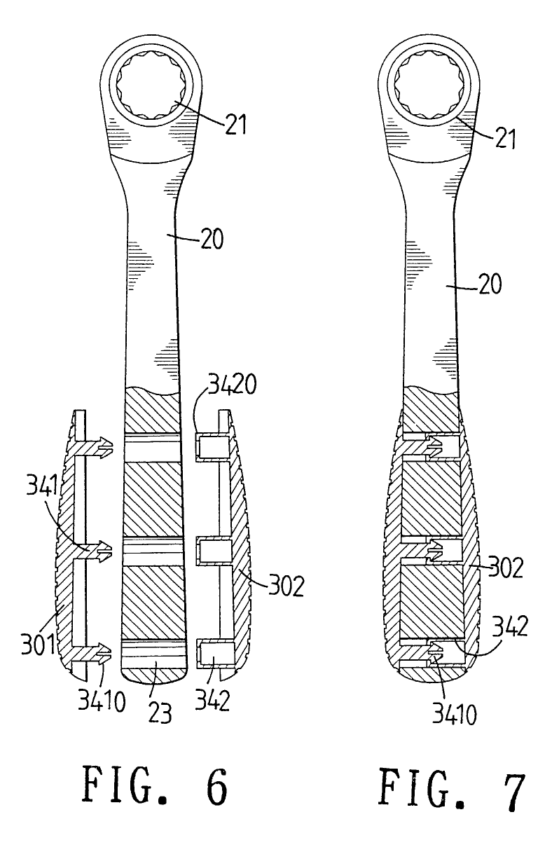

FIGS. 6 and 7 show another embodiment of the present invention,, wherein the handle body 22 has a plurality of through holes 23 defined transversely relative to a longitudinal axis of the handle body 22, a first grip part 301 has a plurality of insertions 341 extending from a side thereof, and a second grip part 302 has a plurality of receiving members 342 located at a side of the second grip part 302. The insertions 341 and the receiving members 342 are respectively received in the through holes in pairs and the insertions 341 are securely engaged with the receiving members 342.

Each of the receiving members 342 is a tubular member with an open end. A flange 3420 extends inward from a periphery of each of the open ends. Each of the insertions 341 has an enlarged head 3410 which includes a slit so that each enlarged head 3410 is composed of two halves separated by the slit. The two halves are narrowed when passing through a hole enclosed by the flange 3420 and then bounce back to their original size and engaged with the flange 3420.

While we have shown and described the embodiment in accordance with the present invention, it should be clear to those skilled in the art that further embodiments may be made without departing from the scope of the present invention.

What is claimed is:

1. A handle assembly for hand tools, comprising:
a handle body having a plurality of recesses defined in two opposite sides of the handle body, and
two grip parts each having a plurality of insertions extending from a side thereof, the insertions securely inserted into the recesses of the handle body.

2. The handle assembly as claimed in claim 1 further comprising a passage defined in a distal end of the handle body and communicating with the recesses, each of the insertions having an enlarged head which includes a slit so that each enlarged head is composed of two halves separated by the slit, the two halves being narrowed when passing through the recesses and then bouncing back to their original size and received in the passage.

3. The handle assembly as claimed in claim 1 further comprising a connection piece connected between the two grip parts.

4. A handle assembly for hand tools, comprising:
a handle body having a plurality of through holes defined transversely relative to a longitudinal axis of the handle body, and a first grip part having a plurality of insertions extending from a
side thereof, a second grip part having a plurality of receiving members located at a side of the second grip part, the insertions and the receiving members respectively received in the through holes in pairs and the insertions are securely engaged with the receiving members.

5. The handle assembly as claimed in claim 4, wherein each of the receiving members is a tubular member with an open end, and a flange extending inward from a periphery of each of the open ends, each of the insertions having an enlarged head which includes a slit so that each enlarged head is composed of two halves separated by the slit, the two halves being narrowed when passing through a hole enclosed by the flange and then bouncing back to their original size and engaged with the flange.
